(19) United States
(12) Patent Application Publication
(10) Pub. No.: US 2018/0081471 A1
(43) Pub. Date: Mar. 22, 2018

(54) TOUCH SCREEN AND MANUFACTURING METHOD THEREOF, DISPLAY DEVICE

(71) Applicants: BOE TECHNOLOGY GROUP CO., LTD., BEIJING (CN); BEIJING BOE DISPLAY TECHNOLOGY CO., LTD., BEIJING (CN)

(72) Inventors: Lianjie QU, Beijing (CN); Zhichao LV, Beijing (CN); Guangdong SHI, Beijing (CN); Shuai LIU, Beijing (CN)

(21) Appl. No.: 15/525,932

(22) PCT Filed: Sep. 14, 2016
(86) PCT No.: PCT/CN2016/098995

§ 371 Date: May 10, 2017

(30) Foreign Application Priority Data
Jan. 5, 2016 (CN) 201610006746.2

(51) Int. Cl. G06F 3/041; G06F 3/044

(52) U.S. Cl. CPC G06F 3/0412; G06F 2203/04103; G06F 3/044

(57) ABSTRACT

Embodiments of the present disclosure disclose a touch screen and a manufacturing method thereof, and a display device. The touch screen comprises a first touch electrode and a second touch electrode located on a substrate and arranged in cross distribution along different directions. The first touch electrode and the second touch electrode are insulated from each other at a cross position. One of the first touch electrode and the second touch electrode comprises a metal bridging line and a plurality of transparent conductive portions arranged at intervals. The metal bridging line electrically connects adjacent transparent conductive portions arranged at intervals at the cross position. The touch screen further comprises an opaque pattern. The metal bridging line corresponds to a position of the opaque pattern. The opaque pattern can be located at a side of the metal bridging line close to a display image.

### RELATED APPLICATIONS

The present application is the U.S. national phase entry of PCT/CN2016/098995, with an international filing date of Sep. 14, 2016, which claims the benefit of Chinese Patent Application No. 201610006746.2, filed Jan. 5, 2016, the entire disclosures of which are incorporated herein by reference.

### TECHNICAL FIELD

The present disclosure relates to the field of touch display technology, particularly to a touch screen and a manufacturing method thereof, as well as a display device.

### BACKGROUND

A capacitive touch screen has become the mainstream touch technology nowadays due to its advantages of high sensitivity, long life time and support for multi-point touch. The capacitive touch screen is further divided into self-inductive touch screen and mutual-inductive touch screen. The mutual-inductive touch screen is further divided into single layer mutual-inductive touch screen and double-layer mutual-inductive touch screen. A driving electrode and a sensing electrode of the single layer mutual-inductive touch screen are formed by the same transparent conductive layer, while a driving electrode and a sensing electrode of the double layer mutual-inductive touch screen are formed by two different transparent conductive layers. In comparison, a manufacturing process of the single layer mutual-inductive touch screen is relatively simple.

As shown in FIG. 1a, for a single layer mutual-capacitive touch screen, a first transparent conductive portion distributed along a row direction and a second transparent conductive portion distributed along a column direction are formed by the same transparent conductive layer. A metal bridging line 11 is formed to connect the broken first transparent conductive portions together, so as to form a driving electrode 1. The second transparent conductive portion is in entirety and does not break, so as to form a sensing electrode 2. There is an insulating layer between the metal bridging line and the sensing electrode 2.

For the current mainstream touch screen manufacturers, it is desired to reduce a lateral touch resistance, i.e., the resistance of the metal bridging line. Therefore, a relatively large width of the metal bridging line is required, which is generally maintained at about 10 μm. However, if the width of the metal bridging line is too large, the light reflected by it to the display image will enter into the human eyes, which may result in a visibility problem, as shown in FIG. 1b. In order to reduce the influence to visibility, the width of the metal bridging line has to be reduced. Hence, there is contradiction between reduction of the resistance of the metal bridging line and reduction of the influence on visibility.

### SUMMARY

Therefore, it is desired to mitigate or avoid the contradiction between reduction of the resistance of the metal bridging line and reduction of the influence on visibility.

According to an aspect, an embodiment of the present disclosure provides a touch screen, comprising a first touch electrode and a second touch electrode located on a substrate and arranged in cross distribution along different directions. The first touch electrode and the second touch electrode are insulated from each other at a cross position. One of the first touch electrode and the second touch electrode comprises a metal bridging line and a plurality of transparent conductive portions arranged at intervals, and the metal bridging line electrically connects adjacent transparent conductive portions arranged at intervals at the cross position. The touch screen further comprises an opaque pattern. The metal bridging line corresponds to a position of the opaque pattern.

According to another aspect, an embodiment of the present disclosure further provides a display device, comprising the touch screen as stated above. The opaque pattern of the touch screen is located at a side of the metal bridging line close to a display image of the display device.

According to a further aspect, an embodiment of the present disclosure further provides a manufacturing method of a touch screen, comprising forming a first touch electrode and a second touch electrode in cross distribution along different directions on a substrate. The first touch electrode and the second touch electrode are insulated from each other at a cross position. One of the first touch electrode and the second touch electrode comprises a metal bridging line and a plurality of transparent conductive portions arranged at intervals, and the metal bridging line electrically connects adjacent transparent conductive portions arranged at intervals at the cross position. The manufacturing method further comprises: forming an opaque pattern. The metal bridging line corresponds to a position of the opaque pattern.

According to an embodiment of the present disclosure, the touch screen comprises a first touch electrode and a second touch electrode arranged in cross distribution. One of the first touch electrode and the second touch electrode comprises a metal bridging line and a plurality of transparent conductive portions arranged at intervals. The metal bridging line electrically connects adjacent transparent conductive portions arranged at intervals at the cross position. The touch screen further comprises an opaque pattern. The metal bridging line corresponds to a position of the opaque pattern. In a display device comprising the above touch screen, the opaque pattern of the touch screen is located at a side of the metal bridging line close to the display image of the display device.

### BRIEF DESCRIPTION OF THE DRAWINGS

In order to explain the embodiments of the present disclosure more clearly, next, the drawings to be used in the description of the embodiments will be introduced briefly. Apparently, the drawings described below are only some embodiments of the present disclosure. For the ordinary skilled person in the art, other drawings can also be obtained based on these drawings without paying any creative work.

FIG. 1a shows a schematic view of distribution of a driving electrode and a sensing electrode of a single layer mutual capacitive touch screen in the prior art;

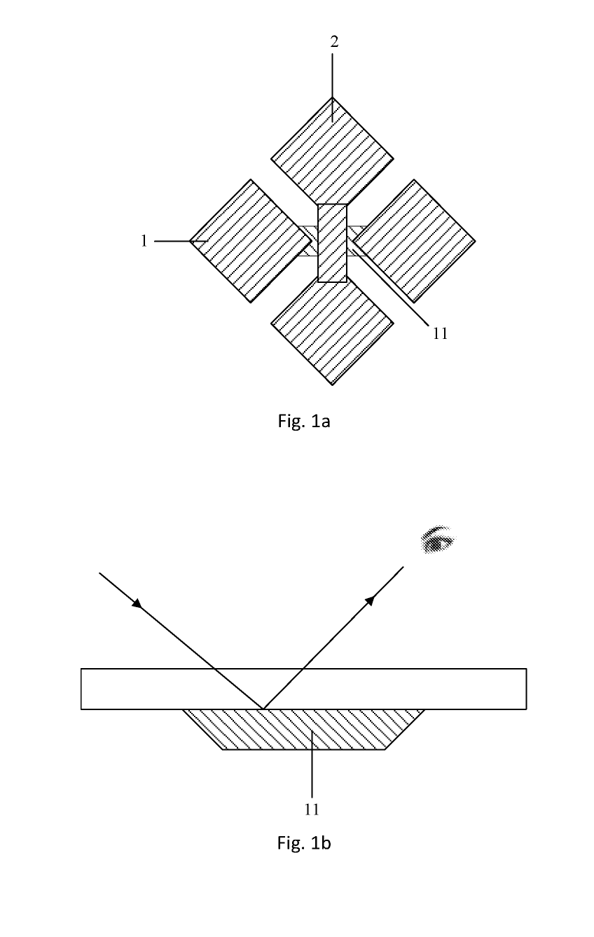

FIG. 1b shows a schematic view of principle of visibility problem existing in the metal bridging line as shown in FIG. 1a;

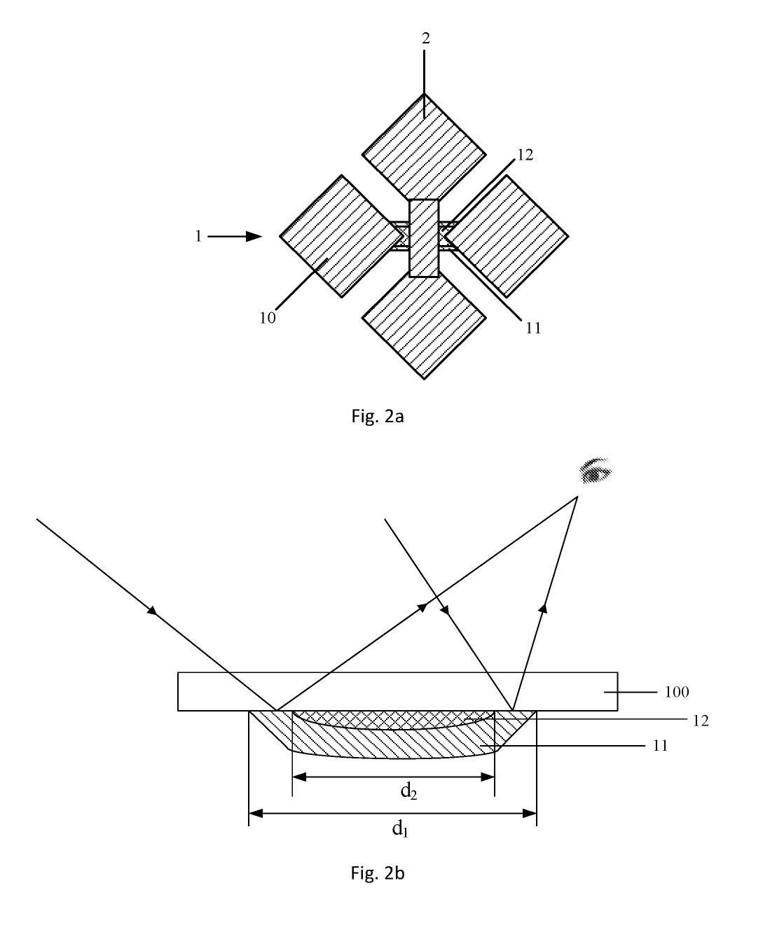

FIG. 2a shows a schematic view of distribution of a driving electrode and a sensing electrode of a single layer mutual-capacitive touch screen in an embodiment of the present disclosure;

FIG. 2b shows a schematic view of a local structure of a position where the metal bridging line of the touch electrode in FIG. 2a locates;

FIG. 3, FIG. 5-FIG. 7 show schematic views of a manufacturing process of a driving electrode and a sensing electrode of a single layer mutual-capacitive touch screen in an embodiment of the present disclosure;

FIG. 4 shows a sectional view of FIG. 3 along line A-A;

FIG. 8 shows a back view I of a single layer mutual-capacitive touch screen in an embodiment of the present disclosure;

FIG. 9 shows a back view II of a single layer mutual-capacitive touch screen in an embodiment of the present disclosure;

FIG. 10 shows a back view III of a single layer mutual-capacitive touch screen in an embodiment of the present disclosure.

### DETAILED DESCRIPTION OF THE DISCLOSURE

A mutual-capacitive touch screen generally comprises a driving electrode and a sensing electrode for generating mutual capacitance. The driving electrode and the sensing electrode are in cross distribution and form a detection capacitance matrix at the cross position. The extending direction of the driving electrode can be set as the first direction, and the extending direction of the sensing electrode can be set as the second direction. For a single layer mutual-capacitive touch screen, a driving electrode and a sensing electrode are formed by the same transparent conductive layer.

The touch screen provided by embodiments of the present disclosure can be a single layer mutual-capacitive touch screen. The touch screen comprises a first touch electrode and a second touch electrode arranged in cross distribution along different directions. The first touch electrode and the second touch electrode are insulated from each other at a cross position. One of the first touch electrode and the second touch electrode comprises a metal bridging line and a plurality of transparent conductive portions arranged at intervals, and the metal bridging line electrically connects adjacent transparent conductive portions arranged at intervals at the cross position. The touch screen further comprises an opaque pattern. The metal bridging line corresponds to a position of the opaque pattern. When the above touch screen is applied in a display device, the opaque pattern of the touch screen is located at a side of the metal bridging line close to the display image of the display device. By means of the touch screen and the display device according to embodiments of the present disclosure, the light reflected by the metal bridging line to the display image can be reduced, and the reflected light will not be distinguished by human eyes, thereby reducing the influence on visibility by the metal bridging line. Further, the width of the metal bridging line can be increased appropriately, so as to reduce its resistance. Therefore, the contradiction between reduction of the resistance of the metal bridging line and reduction of the influence on visibility can be mitigated or avoided.

For example, the first touch electrode can be a driving electrode of the touch screen, and the second touch electrode can be a sensing electrode of the touch screen. Certainly, the first touch electrode can also be the sensing electrode of the touch screen, and the second touch electrode is the driving electrode of the touch screen.

Next, specific embodiments of the present disclosure will be described in more detail with reference to the drawings. The embodiments below are used for explaining the present disclosure but not for limiting the scope of the present disclosure.

In embodiments of the present disclosure, the technical solutions of the embodiments of the present disclosure are described specifically by taking an example that the first touch electrode is the driving electrode of the touch screen and the driving electrode comprises a metal bridging line and a plurality of transparent conductive portions arranged at intervals.

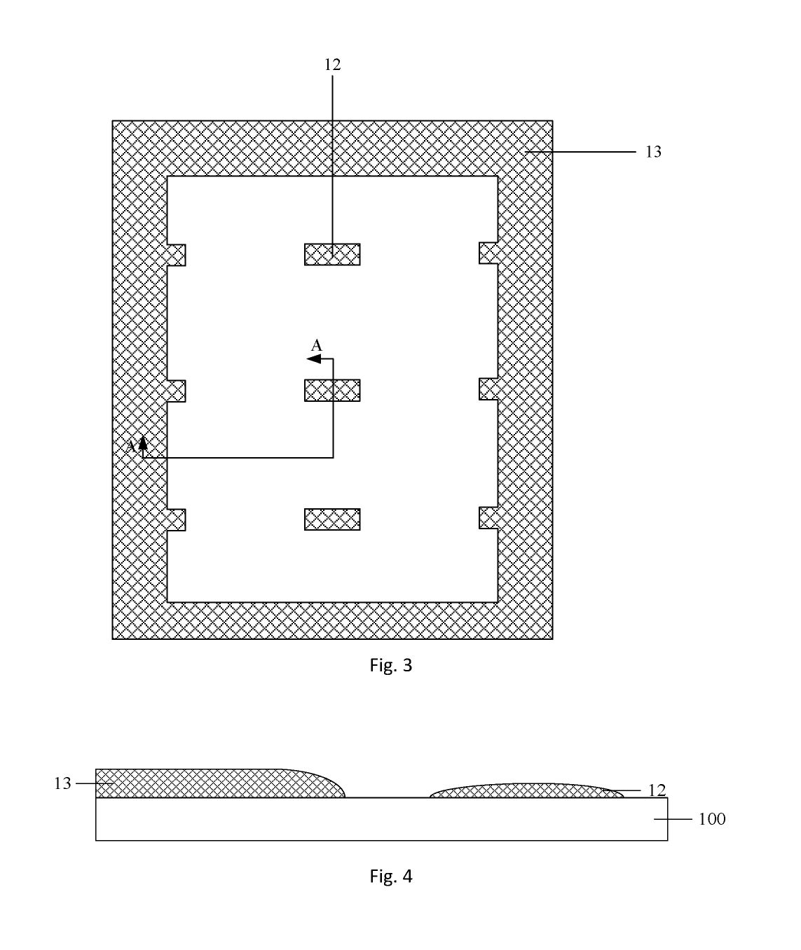

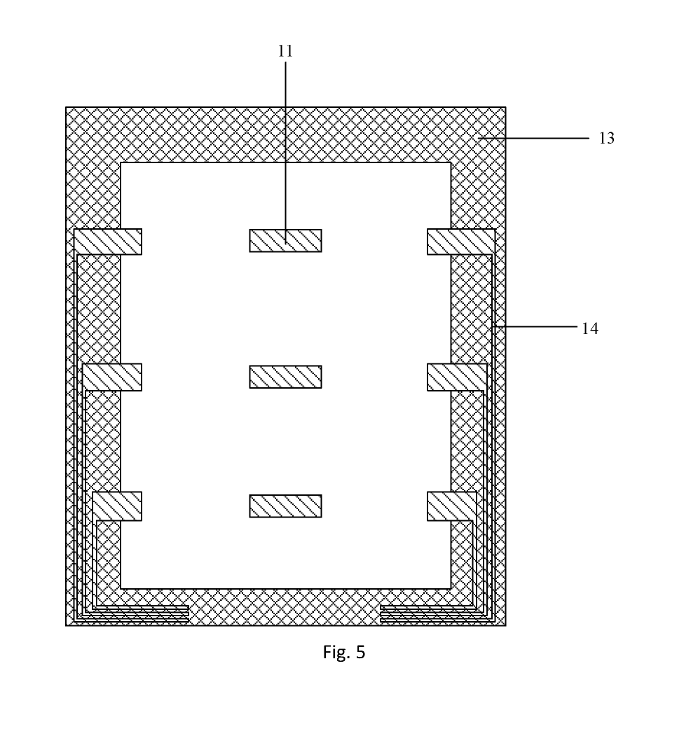

As shown in FIGS. 2a and 2b, a touch screen comprises a transparent substrate 100, as well as a driving electrode 1 extending along a first direction and a sensing electrode 2 extending along a second direction arranged on the substrate 100. The driving electrode 1 and the sending electrode 2 are in cross distribution and are insulated from each other at the cross position. The driving electrode 1 comprises a plurality of first transparent conductive portions 10 distributed along the first direction and a metal bridging line 11. Adjacent first transparent conductive portions 10 are spaced by a certain distance. The metal bridging line 11 is located between adjacent first transparent conductive portions 10, for electrically connecting the adjacent first transparent conductive portions 10 arranged at intervals. The metal bridging line 11 corresponds to the cross position of the driving electrode 1 and the sensing electrode 2.

The touch screen further comprises an opaque pattern 12, and the metal bridging line 11 corresponds to the position of the opaque pattern 12. When the touch screen is applied in a display device, the opaque pattern 12 is located at a side of the metal bridging line 11 close to a display image of the display device. Thus, the light reflected by the metal bridging line 11 toward the display image can be reduced, so as to mitigate or avoid the influence on visibility by the metal bridging line 11, as shown in FIG. 2b.

Although FIGS. 2a and 2b show one metal bridging line 11 and one opaque pattern 12, the number of the metal bridging line and the number of the opaque pattern are not limited to this. Based on specific applications and requirements, the touch screen can comprises a plurality of metal bridging lines and a plurality of opaque patterns.

In this embodiment, the arrangement of the opaque pattern mitigates or avoids influence on visibility by the metal bridging line. By increasing the width of the metal bridging line appropriately, its resistance can be reduced. Thus, the contradiction between reduction of the resistance of the metal bridging line and reduction the influence on visibility can be mitigated or avoided.

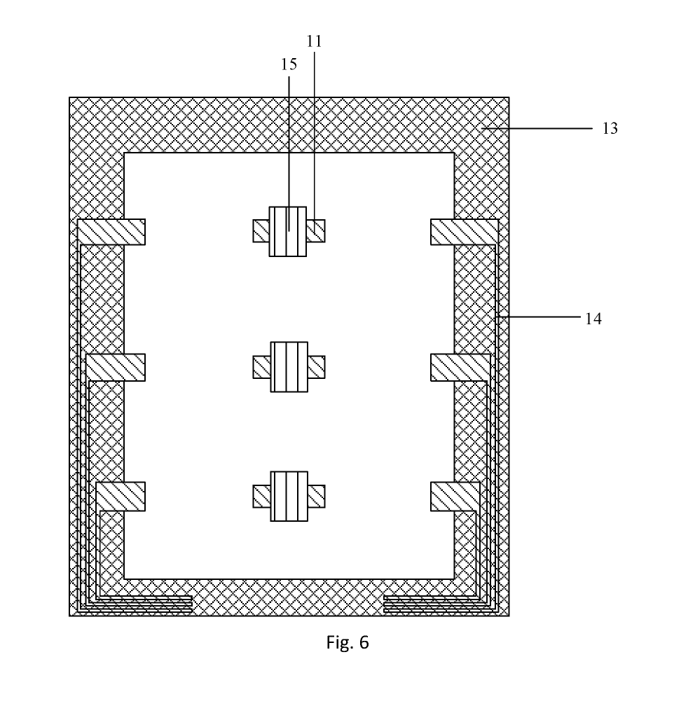

According to another embodiment, the touch screen can further comprise a light shielding area located at the peripheral of a touch area. When the touch screen is applied in a display device, light leakage at the peripheral of the display device can be further prevented. The opaque pattern 12 and a light shielding pattern 13 of the light shielding area can be formed by a patterning process to the same film layer, as shown in FIG. 3.

In order to enable the metal bridging line 11 to correspond to the position of the opaque pattern 12, the opaque pattern 12 can be formed on the metal bridging line 11. Alternatively, the metal bridging line 11 can also be formed on the opaque pattern 12.

In a specific implementation, as shown in FIG. 2b, the metal bridging line 11 is arranged on the opaque pattern 12. The surface of the opaque pattern 12 comprises a slope that is not parallel to the substrate 100 and not perpendicular to the substrate 100. The metal bridging line 11 comprises a portion that covers the slope. An angle between the slope and a first straight line is larger than 0°. The first straight line is parallel to the substrate 100 and an extending direction of the first straight line is perpendicular to an extending direction of the driving electrode 1. Hence, in the event that the projection of the metal bridging line 11 on the substrate 100 is unchanged, the width of the metal bridging line 11 can be increased, so as to reduce the resistance of the metal bridging line 11. Moreover, the design of the slope has a benefit for climbing of the metal bridging line 11, thereby preventing disconnection of the metal bridging line 11. The extending distance of the metal bridging line 11 in a direction perpendicular to the extending direction of the driving electrode 1 is its width.

In order to reduce the resistance of the metal bridging line 11 further, in the direction perpendicular to the extending direction of the driving electrode 1, a width d₁ of a first projection of the metal bridging line 11 on the substrate 100 is larger than a width d₂ of a second projection of the opaque pattern 12 on the substrate 100, for example, 1 μm≦d₁−d₂≦3 μm. The opaque pattern 12 does not shield the metal bridging line 11 entirely, however, it can ensure that the light reflected by the metal bridging line 11 to the display image will not be distinguished by human eyes, thereby mitigating or avoiding the influence on visibility by the metal bridging line 11, as shown in FIG. 2b. In addition, the width of the metal bridging line 11 can also be increased effectively so as to reduce its resistance. Compared to a technical solution that the first projection of the metal bridging line 11 on the substrate 100 is completely located within the second projection of the opaque pattern 12 on the substrate 100, the above technical solution can reduce the area of the opaque pattern 12.

In actual applications, the two features of “slope” and “incomplete shielding” can be combined. That is, the metal bridging line 11 is arranged on the opaque pattern 12, and the opaque pattern 12 comprises the slope that can increase the width of the metal bridging line 11. Meanwhile, the width d₁ of the first projection of the metal bridging line 11 on the substrate 100 is larger than the width d₂ of the second projection of the opaque pattern 12 on the substrate 100, which can reduce the resistance of the metal bridging line 11 more effectively, and reduce the area of the opaque pattern 12.

Although the width of the metal bridging line 11 can be increased to reduce its resistance, the width of the metal bridging line 11 will be limited by an aperture ratio of the display device, which cannot be too large. Hence, the size of the opaque pattern will also be relatively small. Therefore, it is difficult to form the above slope by performing photolithography process through exposure of multi gray scale mask plate. However, the inventor finds that an opaque pattern 12, the edge of which is a slope and the whole thickness of which can also be reduced greatly, can be formed when the size of the opaque pattern 12 is close to the resolution of a photolithography device or smaller. When the metal bridging line 11 that covers the opaque pattern 12 is formed on the opaque pattern 12, it is beneficial for climbing of the metal bridging line 11, thereby preventing disconnection of the metal bridging line 11.

Therefore, according to another embodiment of the present disclosure, the slope of the opaque pattern 12 is located at the edge of the opaque pattern 12, so as to facilitate implementation of the process.

At present, a photolithography resolution of an opaque film layer is about 8-10 μm. In order to form a slope at the edge of the opaque pattern 12, it has to ensure that the size of the opaque pattern 12 is smaller than 8-10 μm. However, considering that too small size may result in fluctuation to of the size easily, hence, it is set in an embodiment of the present disclosure that the width d₂ of the opaque pattern 12 meets the condition: 5 μm≦d₂≦10 μm, thereby forming the required slope and reducing the whole width of the opaque pattern 12. The slope can increase the width of the metal bridging line 11 arranged on the opaque pattern 12, reduce the resistance of the metal bridging line 11 effectively, and prevent disconnection of the metal bridging line due to climbing. The width of the opaque pattern 12 is the extending distance of it in a direction perpendicular to the extending direction of the driving electrode 1. Further, in order to ensure that the size of the opaque pattern 12 meets the requirement and reduce the resistance of the metal bridging line 11, according to another embodiment, the metal bridging line 11 can be arranged on the opaque pattern 12. Thus, the size of the opaque pattern 12 can be reduced, and the width of the metal bridging line 11 can be increased by using the slope of the surface of the opaque pattern 12, so as to reduce the resistance of the metal bridging line 11 effectively.

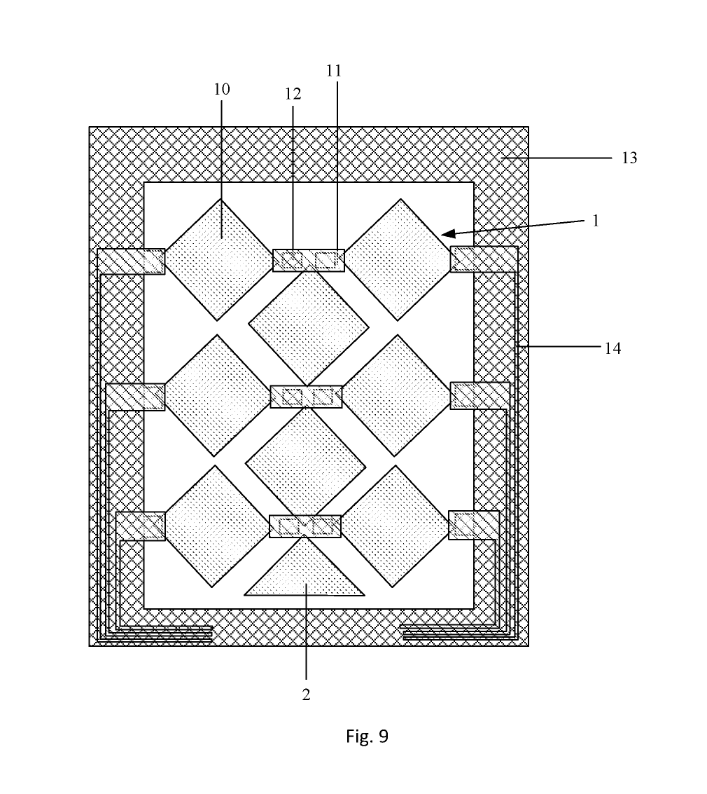

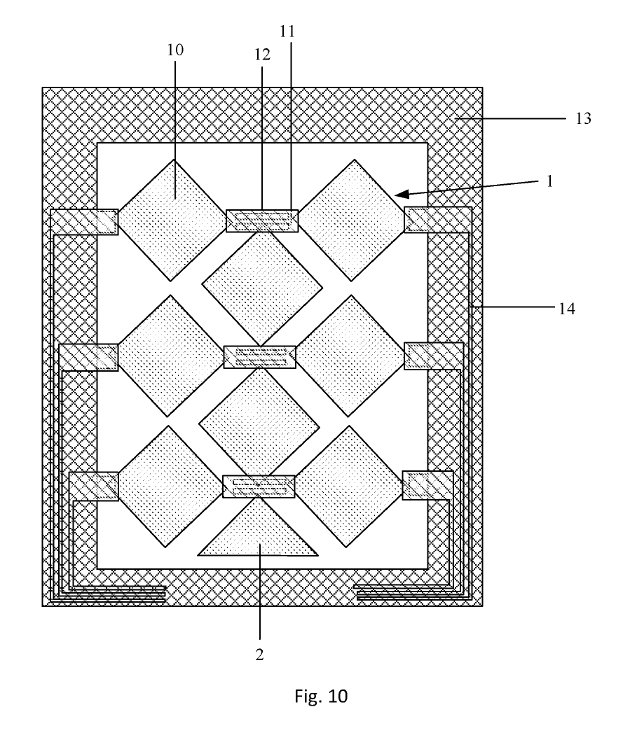

In some cases, when the size of the opaque pattern 12 is still too large, so that the whole thickness of the opaque pattern 12 and the edge slope angle cannot be reduced effectively, in order to ensure that the size of the opaque pattern 12 meets the above condition, the metal bridging line 11 can be made to correspond to the positions of at least two opaque patterns 12. Thus, the size of the opaque pattern 12 can be reduced, so as to reduce the whole thickness of the opaque pattern 12 and the slope angle of the edge slope effectively, as shown in FIGS. 9 and 10 (as an example, which only shows the case in which the metal bridging line 11 corresponds to the positions of two opaque patterns 12). As shown in FIG. 9, an arranging direction of the at least two opaque patterns 12 is consistent with an extending direction of the metal bridging line 11 (which is consistent with an extending direction of the whole driving electrode 1), which requires a higher accuracy of the photolithography device. As shown in FIG. 10, the arranging direction of the at least two opaque patterns 12 is perpendicular to the extending direction of the metal bridging line 11, which does not require a high accuracy of the photolithography device, hence, it has a wider applicability. The gap width between the opaque patterns 12 and the width of the opaque pattern 12 can be far less than an accuracy of the photolithography device, thereby reducing the whole thickness of the opaque pattern 12 and the slope angle of the edge slope effectively.

According to another embodiment of the present disclosure, the metal bridging line 11 of the driving electrode 1 can be arranged on at least two opaque patterns 12. The width d₂ of the opaque pattern 12 meets the condition: 5 μm≦d₂≦10 μm. The arranging direction of at least two opaque patterns 12 is perpendicular to the extending direction of the metal bridging line 11. The width d₁ of the first projection of the metal bridging line 11 on the substrate 100 is larger than the width d₂ of the second projection of all the opaque patterns 12 and the gaps therebetween on the substrate 100, wherein 1 μm≦d₁−d₂≦3 μm. Hence, it can be ensured that the edge of the opaque pattern 12 is a flat slope, and the width of the metal bridging line 11 is increased so as to reduce its resistance effectively. In addition, the influence on visibility by the metal bridging line 11 can also be mitigated or avoided.

According to another embodiment, the opaque pattern as well as the first touch electrode and the second touch electrode can be located in a touch area of the touch screen. The first touch electrode can comprise a metal bridging line and a plurality of transparent conductive portions arranged at intervals, and the plurality of transparent conductive portions are distributed along a row direction. The metal bridging line electrically connects the adjacent transparent conductive portions arranged at intervals in the row direction. Moreover, the second touch electrode can comprise a plurality of other transparent conductive portions. The plurality of other transparent conductive portions extend along a column direction. The plurality of transparent conductive portions and the plurality of other transparent conductive portions are arranged in the same layer.

According to another embodiment, the touch screen can further comprise an insulating layer arranged on the metal bridging line.

According to another embodiment of the present disclosure, the touch screen specifically can comprise the following components.

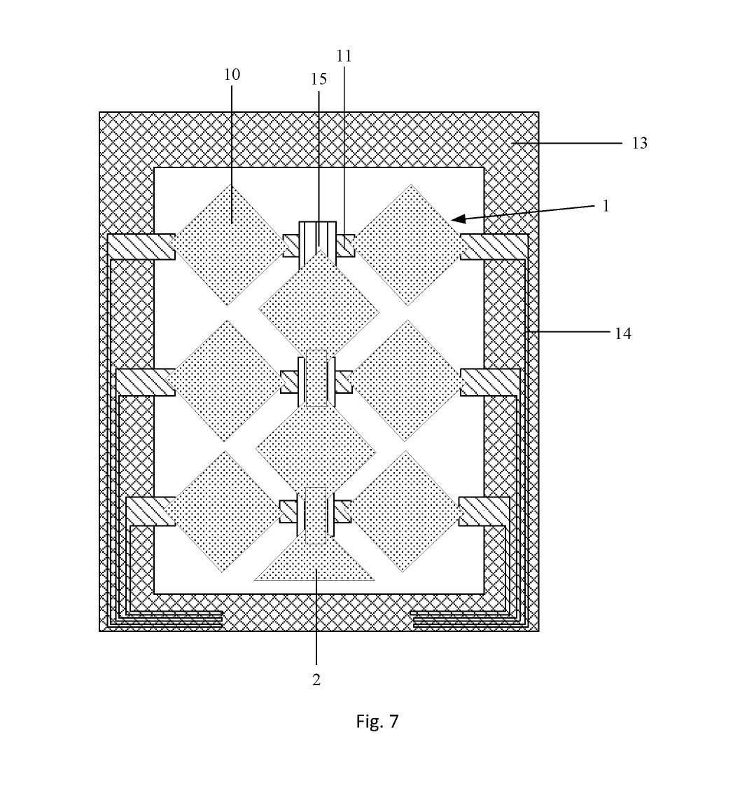

An opaque pattern 12 located in a touch area and a light shielding pattern 13 located at the peripheral of the touch area. The size of the opaque pattern 12 is smaller than the resolution of a photolithography device, thus, the whole thickness of the opaque pattern 12 and the slope angle of the edge slope can be reduced effectively, as shown in FIGS. 3 and 4.

A metal bridging line 11 arranged on the opaque pattern 12 and a signal line 14 for applying a voltage to the driving electrode, as shown in FIGS. 3 and 5.

An insulating layer 15 arranged on the metal bridging line 11, as shown in FIGS. 5 and 6.

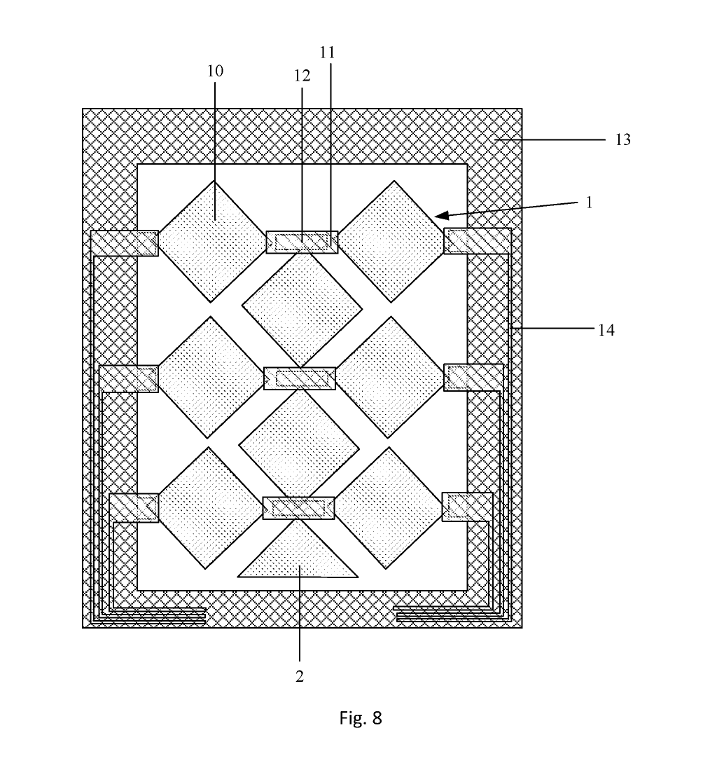

A plurality of first transparent conductive portions 10 located in the touch area and distributed along a row direction and a plurality of second transparent conductive portions for forming the sensing electrode 2, as shown in FIG. 7. The first transparent conductive portions 10 are distributed along the row direction, and the adjacent transparent conductive portions 10 are spaced by a certain distance. In the row direction, the metal bridging line 11 electrically connects the adjacent first transparent conductive portions 10, thereby forming the driving electrode 1, as shown in FIGS. 7 and 8. The second transparent conductive portions extend along a column direction, so as to form the sensing electrode 2, which is in cross distribution with the driving electrode 1, as shown in FIG. 7.

The first transparent conductive portion 10 of the driving electrode 1 and the sensing electrode 2 can be formed by the same transparent conductive layer. The opaque pattern 12 and the light shielding pattern 13 can be formed by the same opaque film layer. The metal bridging line 11 and the signal line 14 can be formed by the same metal film layer. The materials of the first transparent conductive portion 10 and the sensing electrode 2 can be indium zinc oxide or indium tin oxide, such as: one or more of ZnO, IGO, IZO, ITO or IGZO. The material of the metal bridging line 11 can be metals such as Cu, Al, Ag, Mo, Cr, Nd, Ni, Mn, Ti, Ta or W, and alloys of these metals. The opaque pattern 12 and the light shielding pattern 13 can be formed by black organic resin. The material of the insulating layer 15 can be oxynitride.

An embodiment of the present disclosure further provides a display device which can comprise the above touch screen. The opaque pattern of the touch screen is located at a side of the metal bridging line close to the display image of the display device. Thus, the contradiction between reduction of the resistance of the metal bridging line and reduction of the influence on visibility can be mitigated or avoided, so as to improve the display quality of the display device.

An embodiment of the present disclosure further provides a manufacturing method of a touch screen, comprising forming a first touch electrode and a second touch electrode in cross distribution on a substrate (e.g., a glass substrate, a quartz substrate or an organic resin substrate). The first touch electrode and the second touch electrode are insulated from each other at a cross position. One of the first touch electrode and the second touch electrode comprises a metal bridging line and a plurality of transparent conductive portions arranged at intervals, and the metal bridging line electrically connects adjacent transparent conductive portions arranged at intervals at the cross position. The manufacturing method further comprises: forming an opaque pattern. The metal bridging line corresponds to a position of the opaque pattern.

According to another embodiment, the opaque pattern as well as the first touch electrode and the second touch electrode can be located in a touch area of the touch screen. The first touch electrode comprises a metal bridging line and a plurality of transparent conductive portions arranged at intervals, and the plurality of transparent conductive portions are distributed along a row direction. The metal bridging line electrically connects the adjacent transparent conductive portions arranged at intervals in the row direction. Moreover, the second touch electrode comprises a plurality of other transparent conductive portions. The plurality of other transparent conductive portions extend along a column direction. The plurality of transparent conductive portions and the plurality of other transparent conductive portions can be formed by a patterning process of a same transparent conductive layer.

According to another embodiment, the manufacturing method can further comprise forming an insulating layer on the metal bridging line.

The opaque pattern obtained from the above manufacturing method can be located at a side of the metal bridging line close to the display image, which can reduce the light reflected by the metal bridging line to the display image, and enables the reflected light not to be distinguished by human eyes. Thus, the influence on visibility by the metal bridging line can be reduced. Further, the width of the metal bridging line can be increased appropriately, so as to reduce its resistance. Consequently, the contradiction between reduction of the resistance of the metal bridging line and reduction of the influence on visibility can be mitigated or avoided.

According to another embodiment of the present disclosure, the manufacturing method of the touch screen specifically can comprise the following steps.

As shown in FIGS. 3 and 4, an opaque pattern 12 is formed in a touch area, and a light shielding pattern 13 is formed at the peripheral of the touch area. The opaque pattern 12 and the light shielding pattern 13 can be formed by a photolithography process of the same opaque film layer. The size of the opaque pattern 12 is smaller than the resolution of a photolithography device, thus, the whole thickness of the opaque pattern 12 and the slope angle of an edge slope can be reduced effectively.

As shown in FIGS. 3 and 5, a metal bridging line 11 is formed on the opaque pattern 12, and a signal line 14 is formed at the peripheral of the touch area. The metal bridging line 11 and the signal line 14 can be formed by a photolithography process of the same metal film layer. The signal line 14 is used for applying a voltage signal to the driving electrode.

As shown in FIG. 6, an insulating layer 15 is formed on the metal bridging line 11.

As shown in FIGS. 7 and 8, a plurality of first transparent conductive portions 10 and a plurality of second transparent conductive portions for forming a sensing electrode 2 can be formed in the touch area by a patterning process of the same transparent conductive layer. The first transparent conductive portions 10 are distributed along a row direction, and the adjacent first transparent conductive portions 10 are spaced by a certain distance. In the row direction, the metal bridging line 11 electrically connects the adjacent first transparent conductive portions 10, thereby forming a driving electrode 1. The second transparent conductive portions extend along a column direction, so as to form the sensing electrode 2. The sensing electrode 2 and the driving electrode 1 are in cross distribution.

Thus, the manufacturing of the touch screen is finished.

What are stated above are only embodiments of the present disclosure. It should be pointed out that the ordinary skilled person in the art can make various improvements and replacements without departing from the technical principle of the present disclosure. These improvements and replacements should also be regarded as falling within a protection scope of the present disclosure.

1. A touch screen, comprising a first touch electrode and a second touch electrode located on a substrate and arranged in cross distribution along different directions, wherein the first touch electrode and the second touch electrode are insulated from each other at a cross position,
wherein one of the first touch electrode and the second touch electrode comprises a metal bridging line and a plurality of transparent conductive portions arranged at intervals, and the metal bridging line electrically connects adjacent transparent conductive portions arranged at intervals at the cross position, and
wherein the touch screen further comprises an opaque pattern, the metal bridging line corresponds to a position of the opaque pattern.

2. The touch screen according to claim 1, wherein the metal bridging line is arranged on the opaque pattern, and a surface of the opaque pattern comprises a slope that is not parallel to the substrate and not perpendicular to the substrate, and wherein an angle between the slope and a first straight line is larger than 0°, the first straight line is parallel to the substrate and an extending direction of the first straight line is perpendicular to an extending direction of said one of the first touch electrode and the second touch electrode, and the metal bridging line comprises a portion that covers the slope.

3. The touch screen according to claim 2, wherein the slope is located at an edge of the opaque pattern.

4. The touch screen according to claim 3, wherein in a direction perpendicular to the extending direction of said one of the first touch electrode and the second touch electrode, a width d₁ of a first projection of the metal bridging line on the substrate is larger than a width d₂ of a second projection of the opaque pattern on the substrate, wherein 1 μm≦d₁−d₂≦3 μm.

5. The touch screen according to claim 3, wherein in a direction perpendicular to the extending direction of said one of the first touch electrode and the second touch electrode, a width of the opaque pattern is d₂, wherein 5 μm≦d₂≦10 μm.

6. The touch screen according to claim 1, wherein the number of the opaque pattern is plural, and the metal bridging line corresponds to positions of at least two opaque patterns.

7. The touch screen according to claim 6, wherein an arranging direction of the at least two opaque patterns is consistent with an extending direction of the metal bridging line.

8. The touch screen according to claim 6, wherein an arranging direction of the at least two opaque patterns is perpendicular to an extending direction of the metal bridging line.

9. The touch screen according to claim 1, wherein the opaque pattern as well as the first touch electrode and the second touch electrode are located in a touch area.

10. The touch screen according to claim 9, wherein the first touch electrode comprises the metal bridging line and the plurality of transparent conductive portions arranged at intervals, the plurality of transparent conductive portions are distributed along a row direction, the metal bridging line electrically connects adjacent transparent conductive portions arranged at intervals in the row direction, and wherein the second touch electrode comprises a plurality of other transparent conductive portions, the plurality of other transparent conductive portions extend along a column direction, and the plurality of transparent conductive portions and the plurality of other transparent conductive portions are arranged in a same layer.

11. The touch screen according to claim 1, further comprising an insulating layer arranged on the metal bridging line.

12. A display device, comprising the touch screen as claimed in claim 1, wherein the opaque pattern of the touch screen is located at a side of the metal bridging line close to a display image of the display device.

13. A manufacturing method of a touch screen, comprising forming a first touch electrode and a second touch electrode in cross distribution along different directions on a substrate, wherein the first touch electrode and the second touch electrode are insulated from each other at a cross position, one of the first touch electrode and the second touch electrode comprises a metal bridging line and a plurality of transparent conductive portions arranged at intervals, and the metal bridging line electrically connects adjacent transparent conductive portions arranged at intervals at the cross position,
wherein the manufacturing method further comprises: forming an opaque pattern, and the metal bridging line corresponds to a position of the opaque pattern.

14. The manufacturing method according to claim 13, wherein the opaque pattern as well as the first touch electrode and the second touch electrode are located in a touch area.

15. The manufacturing method according to claim 14, wherein the first touch electrode comprises the metal bridging line and the plurality of transparent conductive portions arranged at intervals, the plurality of transparent conductive portions are distributed along a row direction, and the metal bridging line electrically connects adjacent transparent conductive portions arranged at intervals in the row direction, and wherein the second touch electrode comprises a plurality of other transparent conductive portions, the plurality of other transparent conductive portions extend along a column direction, and the plurality of transparent conductive portions and the plurality of other transparent conductive portions are formed by a patterning process of a same transparent conductive layer.

16. The manufacturing method according to claim 13, further comprising forming an insulating layer on the metal bridging line.

17. A display device, comprising the touch screen as claimed in claim 2, wherein the opaque pattern of the touch screen is located at a side of the metal bridging line close to a display image of the display device.

18. A display device, comprising the touch screen as claimed in claim 3, wherein the opaque pattern of the touch screen is located at a side of the metal bridging line close to a display image of the display device.

19. A display device, comprising the touch screen as claimed in claim 6, wherein the opaque pattern of the touch screen is located at a side of the metal bridging line close to a display image of the display device.

20. A display device, comprising the touch screen as claimed in claim 9, wherein the opaque pattern of the touch screen is located at a side of the metal bridging line close to a display image of the display device.
